(19) United States
(12) Patent Application Publication
(10) Pub. No.: US 2014/0218528 A1
(43) Pub. Date: Aug. 7, 2014

(54) Three-Dimensional Sound Human Machine Interface, Navigation, And Warning Systems In A Vehicle

(71) Applicant: HONDA MOTOR CO., LTD., TOKYO (JP)

(72) Inventors: Arthur Alaniz, Mountain View, CA (US); Fuminobu Kurosawa, Mountain View, CA (US)

(73) Assignee: HONDA MOTOR CO., LTD., TOKYO (JP)

(21) Appl. No.: 14/157,762

(22) Filed: Jan. 17, 2014

Related U.S. Application Data
(60) Provisional application No. 61/759,882, filed on Feb. 1, 2013.

(51) Int. Cl. H04S 1/00; H04N 7/18; H04S 5/00

(52) U.S. Cl. CPC H04S 1/002; H04S 5/00; H04N 7/18
USPC 348/148; 381/17

(57) ABSTRACT

Systems and methods for providing a vehicle occupant with a three-dimensional sound human machine interface, three-dimensional sound navigation, and three-dimensional sound warnings. One method includes retrieving a menu option, determining a virtual location of the menu option relative to the vehicle occupant, and emitting audio related to the menu option through a three-dimensional sound system to cause the vehicle occupant to hear the audio at the virtual location. The method also includes receiving feedback from the vehicle occupant related to the menu option and interpreting the feedback to adjust the virtual location of the menu option.

### CROSS-REFERENCE TO RELATED APPLICATIONS

This disclosure claims priority to U.S. Provisional Patent Application No. 61/759,882 filed on Feb. 1, 2013.

### FIELD

The disclosure relates in general to three-dimensional sound systems for a vehicle and, more particularly, to three-dimensional sound human machine interface systems, navigation systems, and warning systems.

### BACKGROUND

Many vehicles include in-vehicle infotainment systems incorporating a display configured to output useful information for the driver. Also, such systems often incorporate a number of user interfaces allowing the driver to control audio, video, and/or navigation systems. Because these systems are often relied upon by the driver while operating the vehicle, they require the driver to glance away from the road in order to view the display and/or the user interfaces. For example, with respect to navigation systems, even by arranging map features to quickly and efficiently communicate information to a driver, these navigation systems can still distract the driver away from the road to see the next direction in a route and/or make selections. In another example, with respect to audio entertainment, the driver must look down away from the road to make a desired selection.

Therefore, what is a needed are systems and methods for providing in-vehicle infotainment that do not cause a driver to be visually distracted from the road.

### SUMMARY

The disclosure relates in general to three-dimensional sound systems for a vehicle and, more particularly, to three-dimensional sound human machine interface systems, navigation systems, and warning systems.

In one implementation, the present disclosure is directed to a method for providing a vehicle occupant with a three-dimensional sound human machine interface. The method can include retrieving a menu option, determining a virtual location of the menu option relative to the vehicle occupant, and emitting audio related to the menu option through a three-dimensional sound system to cause the vehicle occupant to hear the audio at the virtual location. The method can also include receiving feedback from the vehicle occupant relating to the menu option and interpreting the feedback to adjust the virtual location of the menu option.

In another implementation, the present disclosure is directed to a method for providing an occupant of a vehicle with three-dimensional sound navigation. The method can include emitting media system audio through a three-dimensional sound system throughout the vehicle, retrieving navigation audio content, and mapping a physical location corresponding to the navigation audio content relative to the vehicle. The method can also include determining a virtual location within the vehicle corresponding to the physical location and emitting audio relating to the navigation audio content through the three-dimensional sound system to cause the occupant to hear the audio at the virtual location while still hearing the media system audio elsewhere throughout the vehicle.

In yet another implementation, the present disclosure is directed to a three-dimensional sound human machine interface system for a vehicle occupant. The system can include a three-dimensional sound system, a camera configured to record feedback from the vehicle occupant, and a processing system in communication with the three-dimensional sound system and the camera, The processing system can be configured to retrieve a menu option, determine a virtual location of the menu option relative to the vehicle occupant, and emit audio related to the menu option through the three-dimensional sound system to cause the vehicle occupant to hear the audio from the virtual location. The processing system can also be configured to receive the feedback from the vehicle occupant through the camera and interpret the feedback to adjust the virtual location of the menu option.

### BRIEF DESCRIPTION OF THE DRAWINGS

FIG. 1 is a schematic illustration of an exemplary three-dimensional sound human machine interface system, in accordance with one aspect of the present disclosure, for a vehicle.

FIG. 2 is a flow chart illustrating an exemplary method for providing a three-dimensional sound human machine interface system in a vehicle.

FIG. 3 is a schematic illustration of an exemplary three-dimensional sound navigation and warning system, in accordance with another aspect of the present disclosure, for a vehicle.

FIG. 4 is a flow chart illustrating an exemplary method for providing a three-dimensional sound navigation and warning system in a vehicle.

### DETAILED DESCRIPTION OF THE DRAWINGS

The disclosure relates in general to three-dimensional sound systems for a vehicle and, more particularly, to three-dimensional sound human machine interface, navigation, and warning systems.

The present system and method is presented in several varying embodiments in the following description with reference to the Figures, in which like numbers represent the same or similar elements. References throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification can, but does not necessarily, refer to the same embodiment.

The described features, structures, or characteristics of the disclosure can be combined in any suitable manner in one or more embodiments. In the following description, numerous specific details are recited to provide a thorough understanding of embodiments of the system. The system and method can both be practiced without one or more of the specific details, or with other methods, components, materials, and so forth. In other instances, well-known structures, materials, or operations are not shown or described in detail to avoid obscuring aspects of the disclosure.

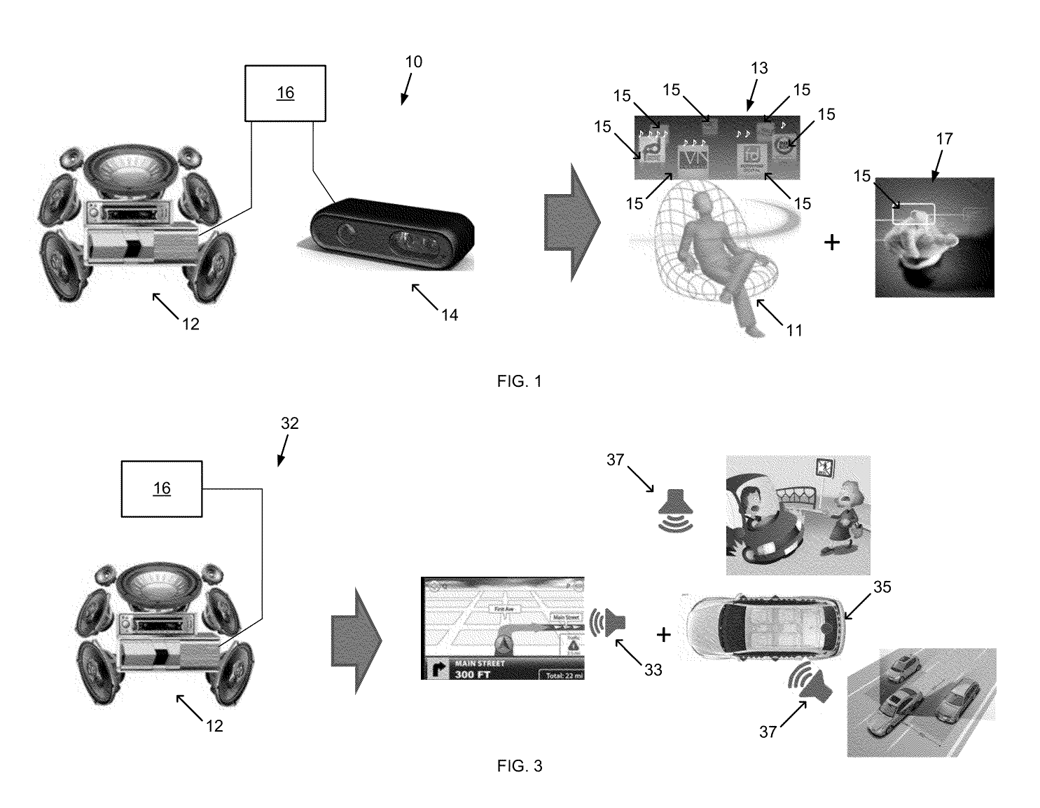

FIG. 1 illustrates a vehicle three-dimensional (3D) sound human machine interface (HMI) system 10, according to one aspect of the present disclosure, including a 3D sound system 12, a camera 14, and a processing system 16. The HMI system 10 enables an occupant 11 of the vehicle, such as the driver, to operate in-vehicle infotainment without having to look at any screens or user interfaces. More specifically, the HMI system 10 enables the driver 11 to make selections for in-vehicle infotainment based on sound and gestures. This prevents eye glance time away from the road and, as a result, minimizes driver distraction.

Generally, the HMI system 10 operates by presenting a menu 13 of virtual options 15 around the driver's head using the 3D sound system 12 to cause the driver to hear or “feel” the menu options 15 at different locations within the vehicle. Through hand gestures 17, as recorded by the camera 14 (e.g., a depth camera) and interpreted by the processing system 16, the driver 11 can select a location in space corresponding to a desired menu option 15.

More specifically, the processing system 16 can control the 3D sound system 12, having a plurality of multichannel speakers 19, to present virtual menu options around the driver or at different locations within the vehicle. For example, the 3D sound system 12 can emit audio so that the driver 11 hears different menu options 15 encircling his head, as shown in FIG. 1. In another example, the 3D sound system 12 can emit audio so that the driver 11 hears a menu option 15 near the front right of the vehicle interior, near the front left, near the middle right, near the middle left, near the rear right, and/or near the rear left and so on. With a smaller menu 13 of options 15, the 3D sound system 12 can emit audio so that the driver hears a different menu option 15 near the front, middle, and rear of the vehicle, respectively. The 3D sound system 12 can play these options 15 simultaneously so that all options 15 are heard at once, or sequentially so that options 15 are heard one after the other. In some cases, the simultaneous or sequential menu audio can be a configurable option selectable by the driver 11

Other embodiments can include specific sounds for the driver seat, or other passengers within the vehicle. For example, the vehicle can have a multi-user head unit. This configuration can allow passengers 11 within the vehicle to log into the head unit so that multiple devices, such as the passengers' smartphones, can add their address books, use the head unit's Bluetooth®, and other associated features that are provided by registering or logging in the smartphone into the head unit. The head unit would be able to determine the seat at which the smartphone is located and can project the 3D sounds towards this seat. For example a call comes in for a backseat passenger 11 (i.e., through that passenger's smartphone, which has been logged into the head unit) and the voice coming in through the call would be projected in the back toward that passenger 11 instead of the front of the vehicle. In this way, the car speakers could be used in a more efficient manner. Special microphones can also be placed in the back or other locations of the vehicle to facilitate this.

In addition, the HMI system 10 can virtually scroll through the menu options 15. For example, the driver 11 can make a swiping gesture that is recorded by the depth camera 14. In one implementation, the processing system 16 can interpret this gesture and control the 3D sound system 12 to rotate the menu options 15 to different locations based on the direction of the swiping gesture. The driver 11 can continue swiping until the desired menu option 15 is heard or “felt” in front of him. Through another hand motion, such as a simple pointing gesture 17 in the forward direction (as shown in FIG. 1), the driver 11 can select the menu option 15 that is now heard in front of him. In another implementation, the processing system 16 can interpret the swiping gesture and control the 3D sound system 12 to play one of the menu options 15 (e.g., a “highlighted” menu option) louder than the others. The driver 11 can continue the swiping gesture until the desired menu option 15 is the loudest and, through another hand motion, select the location of the desired menu option 15.

In one example, a virtual menu 13 can include options 15 for playing media system audio, such as CDs, DVDS, USB-connected media, FM/AM radio, satellite radio, etc. The 3D sound system 12 can play key words as the menu options 15 (e.g., “CD”, “DVD”, “USB”, “FM radio”, etc.) so that they are heard at different locations around the driver 11. Furthermore, a hierarchy of menus 13 can be audibly presented. For example, once a selection for satellite radio is made, a secondary menu 13 of options 15 can be presented for selecting a specific radio station. In another example, sound effects for menus 13 could be presented from different directions for other menu options 15.

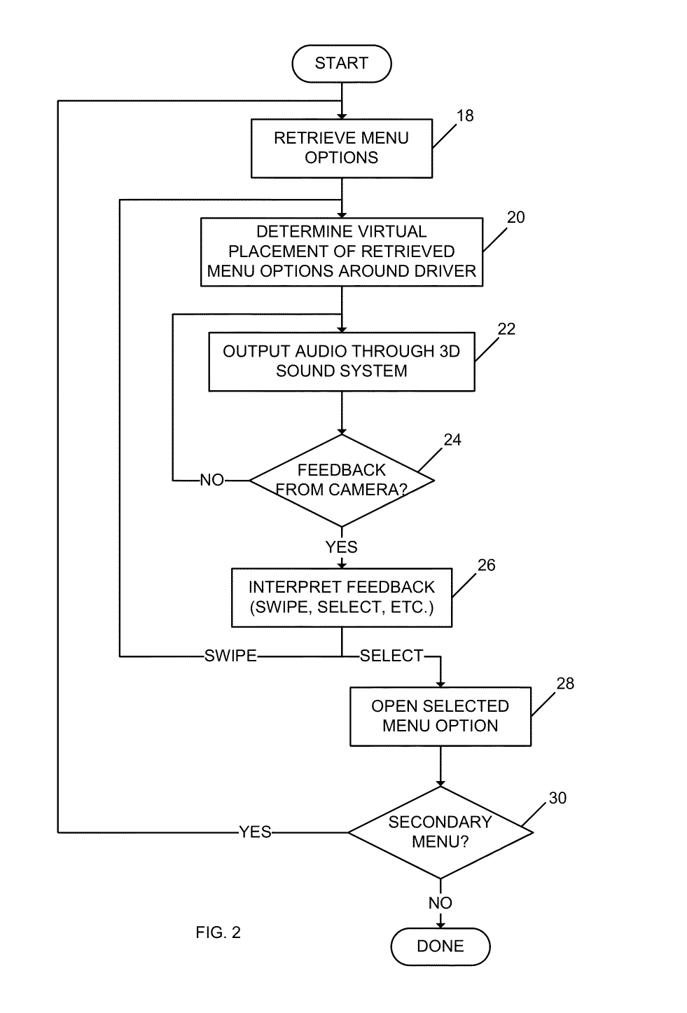

FIG. 2 illustrates a method for implementing the above HMI system 10 according to one aspect of the disclosure. For example, the method can be executed by the processing system 16. At 18, the processing system 16 can retrieve a list of menu options. At 20, based on the number of menu options in the list and/or other factors, the processing system 16 can determine or map the virtual placement and sound level of audible menu options to be presented around the driver. In one example with six menu options, the processing system 16 can map separate menu options at the front right, front left, middle right, middle left, rear right, and rear left of the vehicle, respectively. Following this mapping step, at 22, the processing system 16 can control the 3D sound system 12 to output audible menu options so that, to the driver, they appear to be coming from the mapped locations. The processing system 16 can interpret information from the depth camera 14 to determine if the driver has provided feedback at 24. In some applications, the processing system 16 can continue repeating the output from 22 until driver feedback is received.

Once driver feedback is received, the processing system 16 can determine the type of feedback, such as a swipe gesture or a select gesture, at 26. If a swipe gesture is interpreted, the processing system 16 can revert back to 20 and re-map the virtual placement or sound levels of the menu options. For example, if a right swiping gesture is interpreted, the processing system 16 can virtually move the menu options one location over in a clockwise direction from their previous positions and then continue to 22. In another example, if a right swiping gesture is interpreted, the processing system 16 can increase the volume of an output menu option positioned to the right of a previously highlighted menu option. If a select gesture (e.g., a pointed finger moving straight forward, rather than swiping side-to-side) is interpreted by the processing system 16, the highlighted or front menu option can be selected and opened at 28. If the selected menu option includes a secondary list, as determined at 30, the secondary list is retrieved at 18 and the method is repeated. Otherwise, if the selected menu option does not include a secondary list, as determined at 30, opening that selected menu option can cause that menu option to be executed and specific media system audio can be played throughout the vehicle (e.g., selecting the menu option of USB-connected media will cause such media to be played within the vehicle).

Accordingly, the HMI system 10 and accompanying method of the present disclosure can enable a driver to operate in-vehicle infotainment by gesturing in the air around him without having to look at a user interface or switches to make selections. An interactive menu is heard or “felt” around the driver's head so that selections can be made without visibly distracting the driver. As a result, the driver can spend more time paying attention to the road.

FIG. 3 illustrates a 3D sound navigation and warning system 32 in accordance with another aspect of the present disclosure. While illustrated in FIG. 3 as a combined navigation and warning system 32, according to some applications of the present disclosure, a separate 3D sound navigation system or 3D sound warning system can be provided. With respect to navigation, the system 32 can operate in conjunction with a vehicle's GPS navigation system by enabling a driver to “feel” a route. More specifically, the system 32 can include a processing system 16 in communication with a 3D sound system 12 to output navigation audio 33 at different locations within the vehicle 35 relative to the driver 11 (that is, so that the driver 11 hears audio coming from, for example, the front, rear, or sides of the vehicle 35) based on the content of the navigation audio 33. The processing system 16 can incorporate the GPS navigation or can operate in communication with separate GPS navigation of the vehicle 35.

Example content of the navigation audio 33 can include directions to turn, to continue straight, or to take an upcoming exit, that a destination is quickly approaching or has been passed, etc. This content is based on a known physical location relative to the vehicle 35, as determined by GPS navigation. The system 32 can use the relative physical location to present the navigation audio 33 in a location of the vehicle 35 that corresponds to the relative physical location. For example, if the content of the navigation audio 33 is to turn right in one mile, the system 32 can output audio 33 so that the driver 11 hears these instructions coming from a front right location of the vehicle 35. In another example, if the content is that the driver 11 has passed the destination, the system 32 can output audio 33 so that the driver 11 hears this content coming from the rear of the vehicle 35. Furthermore, if the driver 11 is passing the destination, the driver 11 can hear the audio output 33 move from the front of the vehicle 35 toward the back of the vehicle 35.

In addition, in some applications, the system 32 can adjust the volume level of the audio 33 based on the severity of the content. For example, if the content is that the driver 11 is to turn right in 500 feet, the system 32 can emit audio directions at a louder volume than for content directing the driver 11 to turn right in two miles. In yet another example, the system 32 can manage the content when audio from the vehicle's media system is playing. More specifically, if the content of the navigation audio 33 is to turn right in one mile, the system 32 can output audio 33 so that the driver 11 hears these instructions coming from a front right location of the vehicle 35, while continuing to hear music or other audio throughout the rest of the vehicle 35.

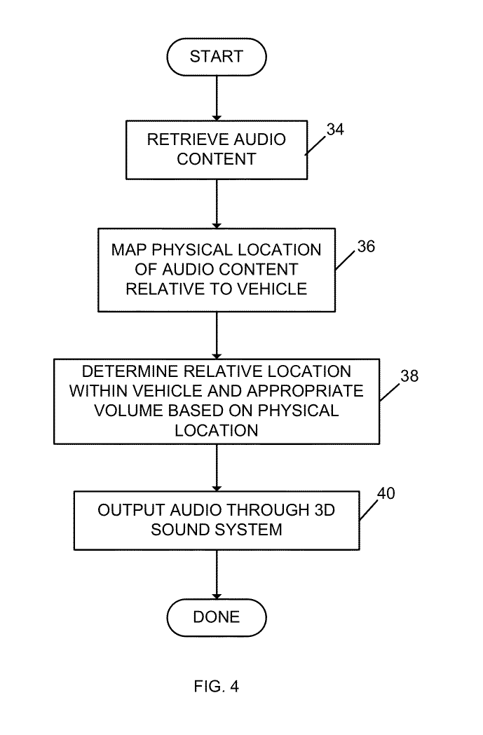

In accordance with the above-described 3D sound navigation and warning system 32, FIG. 4 illustrates a method according to one aspect of the present disclosure. For example, this method can be executed by the processing system 16. At 34, the processing system 16 can retrieve navigation audio content. At 36, the processing system 16 can map a physical location of the audio content (i.e., corresponding to the audio content) relative to the vehicle. It is also contemplated that 36 can be executed first, and then audio content is retrieved based on the physical location. Following 34 and 36, the processing system 16 can determine audio output characteristics based on the physical location, including a relative location within the vehicle and/or an appropriate volume, at 38. Following this determination, at 40, the processing system 16 can output the audio content through the 3D sound system 12 so that the driver hears the content coming from the relative location at the appropriate volume.

The above method and system 32 can also be utilized with respect to warning signals and audio, as shown in FIG. 2, rather than navigation audio. For example, many vehicles are currently equipped with audio warning systems that emit audio content (e.g., beeps, tones, or phrases) to warn a driver of an impending danger. Such dangers can include an object, pedestrian, or other vehicle approaching too close to the vehicle, the vehicle drifting across a lane line, etc. The system 32 can operate in conjunction with the vehicle's other warning systems to map the physical location of the danger relative to the vehicle and retrieve the appropriate audio content 37, as discussed above with respect to 34 and 36. The system 32 can then determine audio output characteristics based on the physical location, including a relative location within the vehicle and/or an appropriate volume (e.g., at 38). Following this determination (e.g., at 40), the system 32 can output the audio content 37 through the 3D sound system 12 so that the driver 11 hears the warning sound coming from the relative location at the appropriate volume. This can allow a driver 11 to not only be alerted of an impending danger, but also quickly alerted of where the impending danger is coming from. In some cases, this can allow quicker reaction time from the driver 11.

Although the present disclosure has been presented with respect to preferred embodiment(s), any person skilled in the art will recognize that changes can be made in form and detail, and equivalents can be substituted for elements of the present disclosure without departing from the spirit and scope of the disclosure. Therefore, it is intended that the present disclosure not be limited to the particular embodiments disclosed, but will include all embodiments falling within the scope of the appended claims.

What is claimed is:

1. A method for providing a vehicle occupant with a three-dimensional sound human machine interface, the method comprising:
retrieving a menu option;
determining a virtual location of the menu option relative to the vehicle occupant;
emitting audio related to the menu option through a three-dimensional sound system to cause the vehicle occupant to hear the audio from the virtual location;
receiving feedback from the vehicle occupant relating to the menu option; and
interpreting the feedback to adjust the virtual location of the menu option.

2. The method of claim 1, comprising interpreting the feedback to select the menu option.

3. The method of claim 2, wherein the feedback includes one of a swipe gesture and a select gesture.

4. The method of claim 2, wherein selecting the menu option includes emitting media system audio related to the menu option through the three-dimensional sound system throughout the vehicle.

5. The method of claim 2, wherein selecting the menu option includes retrieving a new menu option.

6. The method of claim 1, comprising recording the feedback through a depth camera.

7. The method of claim 1, comprising interpreting the feedback to adjust a volume of the audio.

8. The method of claim 1, comprising retrieving a second menu option;
determining a second virtual location of the second menu option relative to the vehicle occupant; and emitting second audio through the three-dimensional sound system to cause the vehicle occupant to hear the second audio from the second virtual location one of simultaneously and sequentially with the audio from the virtual location.

9. A method for providing an occupant of a vehicle with three-dimensional sound navigation, the method comprising:
emitting media system audio through a three-dimensional sound system throughout the vehicle;
retrieving navigation audio content;
mapping a physical location corresponding to the navigation audio content relative to the vehicle;
determining a virtual location within the vehicle corresponding to the physical location; and
emitting audio relating to the navigation audio content through the three-dimensional sound system causing the occupant to hear the audio at the virtual location while hearing the media system audio elsewhere throughout the vehicle.

10. The method of claim 9, comprising determining a volume level corresponding to the physical location, and emitting the audio at the volume level.

11. The method of claim 9, comprising:
retrieving warning audio content;
mapping a second physical location corresponding to the warning audio content relative to the vehicle;
determining a second virtual location within the vehicle corresponding to the second physical location; and
emitting second audio related to the warning audio content through the three-dimensional sound system to cause the occupant to hear the second audio from the second virtual location.

12. A three-dimensional sound human machine interface system for a vehicle occupant, the system comprising:
a three-dimensional sound system;
a camera recording feedback from the vehicle occupant; and
a processing system in communication with the three-dimensional sound system and the camera, the processing system configured to:
retrieve a menu option,
determine a virtual location of the menu option relative to the vehicle occupant,
emit audio related to the menu option through the three-dimensional sound system to cause the vehicle occupant to hear the audio from the virtual location,
receive the feedback from the vehicle occupant through the camera, and
interpret the feedback to adjust the virtual location of the menu option.

13. The three-dimensional sound human machine interface system of claim 12, wherein the processing system interprets the feedback to select the menu option.

14. The three-dimensional sound human machine interface system of claim 13, wherein the feedback includes one of a swipe gesture and a select gesture.

15. The three-dimensional sound human machine interface system of claim 12, wherein the processing system interprets the feedback to adjust a volume of the audio emitted through the three-dimensional sound system.

16. The three-dimensional sound human machine interface system of claim 12, wherein the processing system is configured to:
retrieve navigation audio content,
map a physical location corresponding to the navigation audio content relative to the vehicle,
determine a second virtual location within the vehicle corresponding to the physical location, and
emit second audio through the three-dimensional sound system to cause the occupant to hear the second audio from the second virtual location.

17. The three-dimensional sound human machine interface system of claim 16, wherein the processing system emits media system audio through the three-dimensional sound system throughout the vehicle simultaneously with the second audio to cause the occupant to hear the second audio at the second virtual location while still hearing the media system audio elsewhere throughout the vehicle.

18. The three-dimensional sound human machine interface system of claim 12, wherein the processing system is further configured to:
retrieve warning audio content,
map a physical location corresponding to the warning audio content relative to the vehicle,
determine a second virtual location within the vehicle corresponding to the physical location, and
emit second audio through the three-dimensional sound system to cause the occupant to hear the second audio from the second virtual location.

19. The three-dimensional sound human machine interface system of claim 12, comprising a head unit in communication with the processing system and communicates with a passenger device; wherein the processing system is configured to:
determine a second virtual location within the vehicle corresponding to a physical location of the passenger device, and
emit second audio through the three-dimensional sound system to cause the occupant to hear the second audio from the second virtual location.

20. The three-dimensional sound human machine interface system of claim 19, wherein the passenger device is a smartphone.
